(19) United States
(12) Patent Application Publication
(10) Pub. No.: US 2003/0204501 A1
(43) Pub. Date: Oct. 30, 2003

(54) Method and system for improving reliability of search engine information

(76) Inventor: Sung Ub Moon, Richmond (CA)

Correspondence Address: KLARQUIST SPARKMAN, LLP, 121 SW SALMON STREET, SUITE 1600, PORTLAND, OR, 97204, US

(21) Appl. No.: 10/425,098

(22) Filed: Apr. 28, 2003

(30) Foreign Application Priority Data
Apr. 26, 2002 (KR) 10-2002-0022845

(51) Int. Cl. G06F 7/00

(52) U.S. Cl. 707/3

(57) ABSTRACT

A method and system for improving the reliability of search results from a search engine by linking third parties having information relevant to a searcher's query directly to that searcher. The search engines maintain a database of searchers and their contact information and a registered searcher inputs a query to that search engine that matches keywords or other parameters linked to a particular third party or third parties, that third party or third parties can choose to respond directly to the searcher with information relevant to the searcher's query. The third party may thereby disseminate useful information which it desires that searcher to have and which is relevant to the searcher's query and the searcher obtains information directly relevant to his or her query.

### FIELD OF THE INVENTION

The present invention relates generally to improvements to Internet searching and retrieval of information. More particularly, the present invention relates to improvements to Internet search engines enabling a third party to link directly to a specific user to provide the user with the information specific to that user's query.

### BACKGROUND OF THE INVENTION

The Internet and more particularly the World Wide Web has grown dramatically both in the amount of information which can be obtained and the number of users connected to the Internet. The Internet has become a valuable research tool enabling users in virtually any location with access to the Internet to search for, access and download information on an endless array of topics. The amount of information available through the Internet is increasing substantially on daily basis. While this provides significant advantages for searchers in providing a large database of potential information relevant to a particular topic, the expansive nature of the Internet also causes problems.

In order to maximize the opportunity for locating relevant information most searchers on the Internet make use of so-called “search engines”, that is facilities which provide tools for searching the Internet, usually based on the entry of a keyword or words by a searcher accessing the search engine through the Internet. The search engine then retrieves a list of web sites, usually ranked based on apparent relevance to the search query, and a searcher may then access Web pages located by the search by clicking through links on the search engine's response page.

The difficulty with this approach is that often information returned by a search engine contains a vast amount of information which is irrelevant to the searcher's keyword query. These irrelevant entries are located by the search engine for various reasons, including web site owners who take steps to improve their web site's ranking by using various techniques which skew results so that the web site appears on search engine search pages at a higher ranking, or appear on pages for a particular keyword or words for which that web site as little or no relevance. The irrelevant entries can also appear on a search engine's response page quite innocently due to the nature of the search parameters selected by the searcher which may correspond with similar parameters used legitimately on a web site, even though the web site itself may have no relevance to the searcher's query.

As the Internet grows and as web sites develop more sophisticated techniques for skewing search results from search engines, the problem of irrelevant search results will increase thereby reducing the effectiveness of searching using a search engine. If searchers are repeatedly provided with search engine response pages containing a vast amount of irrelevant web site references, even if there are a few relevant web page references among those irrelevant entries, they will begin to view search results with a high degree of scepticism and may resort to alternate search means. This will ultimately reduce the effectiveness of the Internet as a research tool and resource for locating information and reduce reliance by searchers on Internet search engines. This also means that those search engines which can improve the reliability of search results for their users will have a competitive advantage over search engines unable to provide users with information relevant to a search query. Searchers will soon discover the search engines which are better at providing reliable results and will migrate their search activities to those search engines and away from search engines which provide less reliable search results.

From a searcher's perspective Internet searching, as compared to other means of obtaining information, is only as effective as the means for returning accurate, relevant materials. This, to a large extent, is the reason why search engines themselves have become the most popular means for searching the Internet. Because of the vast amount of information accessible on the Internet, the potential for retrieving relevant information is much greater for most searches, as compared to other means of obtaining information. However, if irrelevant information is included is a part of a search engine's response page, this can often result in relevant information being “buried” among a vast amount of irrelevant information. It can often be extremely time-consuming for a searcher to sort through vast amounts of irrelevant information in order to locate relevant information. Even worse, the irrelevant information can push relevant information further down a search engine's response page or pages to a point where a searcher gives up before locating that relevant entry.

In many cases there exists third party companies which have a direct interest, whether commercial or otherwise, in providing relevant information to those searching the Internet for specific information available for dissemination by those companies. Those third party companies have no means of locating and communicating with those searchers many of which would want to receive that information if made available to them.

For example, if an Internet searcher, using an Internet search engine, wishes to locate a used car of a particular make and model for sale within a particular price range and which is located geographically near the searcher, an inquiry to a typical Internet search engine would provide that searcher with a plethora of useless information. This might includes information about new vehicles, information about vehicles outside of the searcher's geographical location, information about insuring motor vehicles, and other non-relevant information. What the searcher wants is a response identifying the particular vehicle in question, its price range within the parameters established in the search query and the name and address of a nearby dealer who is offering to sell that used vehicle. If a car dealer was linked to the search engine as a third party entitled to access the searcher's query that dealer would welcome the opportunity of providing the searcher with the specific information of interest to that searcher.

There is need to increase the reliability of the results of Internet searching using Internet search engines. There is also need to provide Internet searchers with information specific to their Internet search queries from reliable sources wishing to impart that information to those searchers. There is a further need to enable third parties who have resources to provide reliable information to Internet searchers to communicate with those searchers in provide them with information specific to their queries. There is a need to ensure that those third parties are controlled to ensure that only information relevant to a searcher's inquiry are provided and that no unnecessary or irrelevant material is provided which might reduce the effectiveness of such a search process.

### SUMMARY OF THE INVENTION

The present invention provides a method and system for improving the reliability of search results from a search engine by linking third parties having information relevant to a searcher's query directly to that searcher. The search engines maintained a database of searchers and their contact information. When a registered searcher inputs a query to that search engine that matches keywords or other parameters linked to a particular third party or third parties, that third party or third parties can choose to respond directly to the searcher with information relevant to the searcher's query. The third party may thereby disseminate useful information which it desires that searcher to have and which is relevant to the searcher's query. The searcher obtains information directly relevant to his or her query. The search engine's reputation is enhanced with an increase in the reliability of searches undertaken by registered searchers. An increase of search traffic to that search engine will normally follow. The search engine also benefits by receiving consideration from third parties for the privilege of being permitted to communicate directly with searchers to provide them with relevant information.

In an embodiment of the invention a method of improving the reliability of search results through an Internet search engine includes the steps of (a) obtaining contact information from a third party desiring to provide information relating to specific subject matter to an Internet user making a search query relating to that subject matter through the search engine; (b) storing the third party's contact information and specific subject matter in a third party database record; (c) obtaining the contact information of an Internet user desiring to make a search query to an Internet search engine web site; (d) storing that Internet user's contact information in a user database record; (e) receiving a search query from the Internet user through the Internet search engine; (f) providing the Internet user with the search results containing web site references based on the search query; and (g) if the search query of the Internet user relates to the specific subject matter, providing the third party with the Internet user's contact information to enable the third party to contact that Internet user to provide the information relating to the specific subject matter to the Internet user.

The method may include, after step (f), only if the third party's web site reference appears as a part of the search results, proceeding to step (g).

The method may include, at step (c), associating one or more key words with the third party, the key words corresponding to the subject matter; at step (d), storing the key words in the third party database record; and after step (f), determining key words based on the search query and only if one or more of the keywords associated with the third party match any of the key words based on the search query, proceeding to step (g).

The method may include, at step (c), obtaining assurances from the third party that the third party will only provide Internet Users with the information relating to the specific subject matter and the third party's contact information.

The method may include, at step (c), obtaining assurances from the third party that the third party will only contact the Internet User once for each query and only to provide the Internet User with the information relating to the specific subject matter and the third party's contact information.

The method may include, at step (g) advising the third party that a query from the Internet user relates to the specific subject matter.

The method may include, at step (g), wherein providing the third party with the Internet user's contact information is undertaken by providing the Internet user's contact information to the third party whenever the search engine receives a query which relates to the specific subject matter from the Internet user.

The method may include, at step (g) wherein providing the third party with the Internet user's contact information is undertaken by providing access to the third party to the database record of the Internet user making the query that relates to the specific subject matter.

The method may include, after step (g), monitoring the information provided by the third party to the Internet user to ensure that only the information relating to the specific subject matter and the third party's contact information are provided by the third party to the user.

In a further embodiment, a system for improving the reliability of search results through an Internet search engine includes the steps of: (a) a third party database for storing a record of third party contact information and information relating to specific subject matter provided by the third party; (b) a Internet user database for storing a record of an Internet user who has agreed to receive the information relating to specific subject matter from the third party; (c) means for receiving a search query from the Internet user, undertake a search of the Internet based on the search query and providing the search results to the Internet user; (d) determining means for determining if the search query of the Internet user relates to the specific subject matter stored in the third party database record; and (e) means for providing the third party with the Internet user's contact information from the Internet user database record to enable the third party to contact that Internet user to provide the information relating to the specific subject matter to the Internet user if the determining means determines that the search query of the Internet user relates to the specific subject matter.

In a further embodiment a method of linking an Internet user inputting a query using an Internet search engine with a third party desiring to provide information relevant to the query of that Internet user; includes the steps of (a) obtaining the contact information of the Internet user; (b) storing the Internet user's contact information in an Internet users database record; (c) obtaining a query from the Internet user through the Internet search engine; (d) undertaking an Internet search by means of the Internet search engine based on the query and providing the search results to the Internet user; and (e) providing the Internet users contact information contained in the Internet user's database record to a third party having information relevant to the query to enable the third party to contact the Internet user directly by means of the Internet user's contact information to provide the Internet user with the information relevant to the query.

### DESCRIPTION OF THE DRAWINGS

FIG. 1 is a block diagram illustrating the basic components used to implement the subject invention;

FIG. 2 is a flow chart illustrating the subject invention from the perspective of an Internet user accessing the Internet search engine;

FIG. 3 is a flow chart illustrating the subject invention from the perspective of a third party;

FIG. 4 is a flow chart illustrating the Internet user registration process of the subject invention;

FIG. 5 is a block diagram illustrating the Internet user registration process of the subject invention;

FIG. 5-1 is a table illustrating user profile records;

FIG. 6 is a flow chart illustrating the search process of the present invention;

FIG. 7 is a flow chart illustrating the provision of information from the third party to the Internet user;

FIG. 7-1 is a diagram illustration of a third party registration form;

FIG. 8 is a diagram illustration of a user registration form;

FIG. 9 is a block diagram illustrating the flow of information from the Internet user to the user database;

FIG. 9-1 is a table illustrating user profile records with search queries;

FIG. 10 is a block diagram illustrating the flow of information between the Internet user, the search engine and the third party when a search query is made;

### DETAILED DESCRIPTION

The method and system for improving the reliability of search engine information will be described with reference to the drawings. These details are provided in order to fully set forth a preferred embodiment of the inventions, and not to limit the scope of the invention; the scope of the invention is defined only by the appended claims.

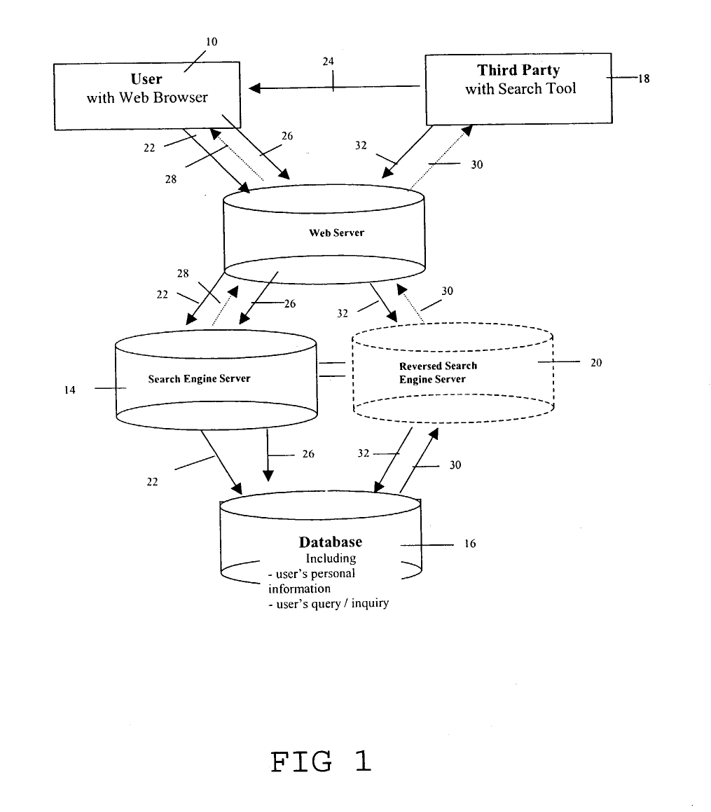

Referring to FIG. 1, the subject invention is depicted in the general manner in accordance with one embodiment of the invention. User 10 having a computer with a Web browser linked to the Internet is able to access WebServer 12 operated by an Internet search engine in the normal manner. The Internet search engine operates by means of search engine server 14 which contains appropriate software and hardware to operate the functions of an Internet search engine. The search engine server 14 is further linked to computer database 16 which contains personal information of user 10 in the event that user 10 wishes to obtain third party information as discussed further detail below. Third party 18 with a computer with search software is linked to the Internet and is able to access WebServer 12 operated by the Internet search engine. Third party 18 accesses reverse search engine server 20 linked to database 16 through WebServer 12. Optionally the search engine server 14 and the reverse search engine server 20 can be the same server.

The present invention does not change the manner in which the Internet search engine handles queries from Internet users. These queries constitute keywords or other search terms which are used by the search engine to search the Internet and to return results to the Internet user which usually contain a list of WebSite references based on the search query. Users 10 are able to perform searches using the Internet search engine in the same manner as prior to adopting the method and system of the present invention.

In the event that user 10 wishes to take the benefit of the subject invention and obtain third party 18 information relating to the search query made by user 10, user 10 must register with the Internet search engine in provide certain information to enable a third party 18 to contact the user 10 directly. As represented by arrow 22, information flows from user 10 to WebServer 12 then to WebServer 14 and finally to database 16 where it is stored for future reference.

This information is made up of the User's personal information (sometimes referred to as the user's profile), and includes contact information which would allow third party 18 to directly contact user 10 to provide information relevant to a query by user 10 directly to user 10, as represented by arrow 24. The query by user 10 is undertaken in the usual manner for undertaking searches using a search engine over the Internet, the flow of information relating to the query represented by arrows 26. The query information flows from user 10 to WebServer 12 and then from WebServer 12 to search engine server 14 where the search software undertakes an Internet search and provides the results to user 10 in the usual fashion.

The user's profile is stored in the Database after being categorized in accordance with a desired categorization parameter, such as industry group, keywords, etc. The categorization of the third party can be included in a field of the user profile record. The software resident on search engine server 14 informs the user of the successful completion of the registration of the user with the search engine, the flow of information represented by arrows 28. The Internet search engine can optionally take steps following the registration of user 10, and based on the user's profile, to validate the accuracy of the information in the user's profile. This personal registration is required to make sure the user's profile is accurate and to prevent the fraudulent use of the search service through the Internet search engine.

Third party 18 has direct access to database 16 in order to obtain a copy of the user's profile, as represented by arrow 30. Third party 18, through its user agreement with the Internet search engine, is authorized to use the contact information contained in the user's profile in order to contact the user directly with information relating to the user's query, as depicted by arrow 24.

When user 10 provides a search query through WebServer 12 to search engine server 14 the query is stored in database 16 in a record tied to a user's profile.

A third party 18 desiring to provide Internet users making search queries of the Internet search engine with information specific to those queries must first register with the Internet search engine, the flow of information depicted by arrows 32. Registration could involve payment of a fee to the Internet search engine or other consideration in exchange for the opportunity to provide information to those Internet users. This information is stored in a third party database record which can be stored in database 16 or a separate database (not shown). The third party 18 information includes a description of the specific subject matter which third party 18 wishes to impart to user 10 in the event that the search query of user 10 relates to that subject matter. This will enable the Internet search engine to ensure that only information relevant to a user 10 search query will be provided to user 10 by third party 18 as depicted by arrow 24.

Third party 18, once registered, is able to search database 16 for a user search query which relates to the specific subject matter contained in the third party 18 information. If such a search query is located third party 18 may access the user's profile linked with that query in order to obtain contact information for user 10, the flow of information depicted by arrows 30. Third party 18 then provides user 10 with information specific to that subject matter as depicted by arrow 24. Optionally, the Internet search engine can control third party 18 access to database 16 to verify that a user's search query relates to the third party's 18 subject matter as stored in the third party's database record before providing the user's contact information for that query. As a further option, third party 18 is only permitted to access the user's profile to obtain contact information for that user if the third party's web site reference is contained on the search report provided to the user 10 when the Internet search engine undertakes the search relating to that query.

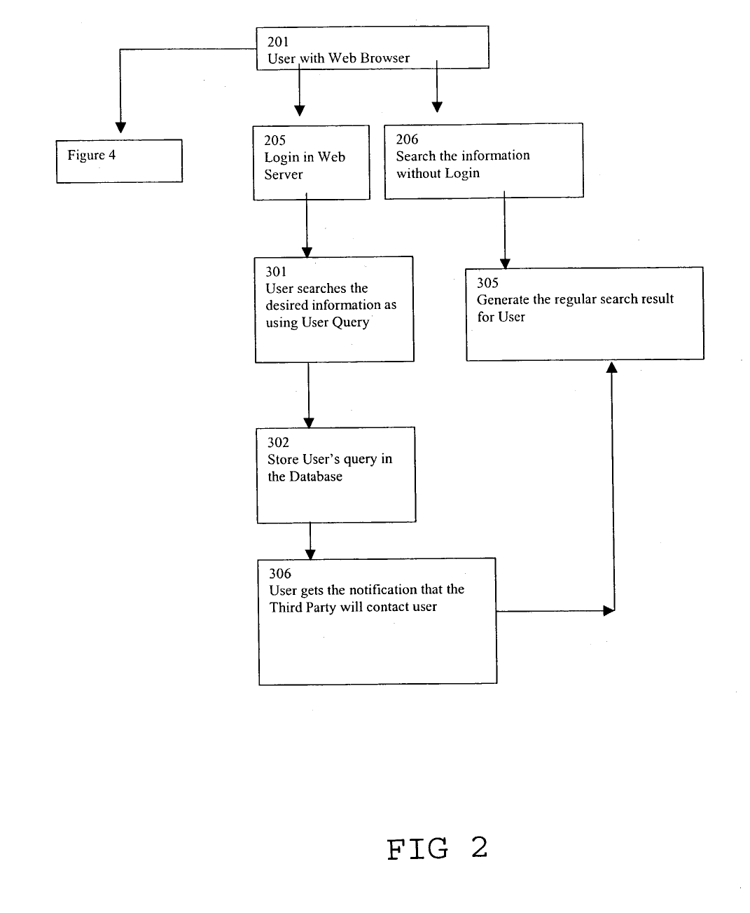

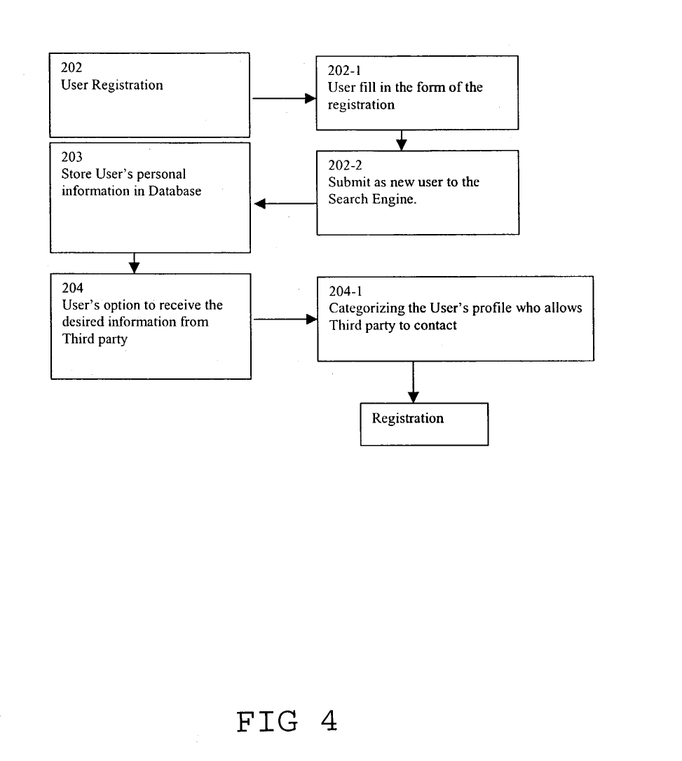

FIG. 2 is a flow chart illustrating the subject invention from the perspective of Internet user 10 accessing the Internet search engine in order to undertake an Internet search in accordance with the present invention. FIG. 4 is a flow chart illustrating the manner in which user 10 is registered with the search engine in order to receive information relating to the user's search queries, directly from third parties.

User 10 with a computer having Web browser software is connected to the Internet (block 201). When user 10 wishes to undertake an Internet search using an Internet search engine which utilizes the subject invention, user 10 accesses the Internet search engine's web site through the Internet. If user 10 has not registered with the Internet search engine to receive information from third parties a screen display provides user 10 with the option of so registering. If user 10 indicates that he wishes to register to receive third party information user 10 is directed to the process depicted in FIG. 4.

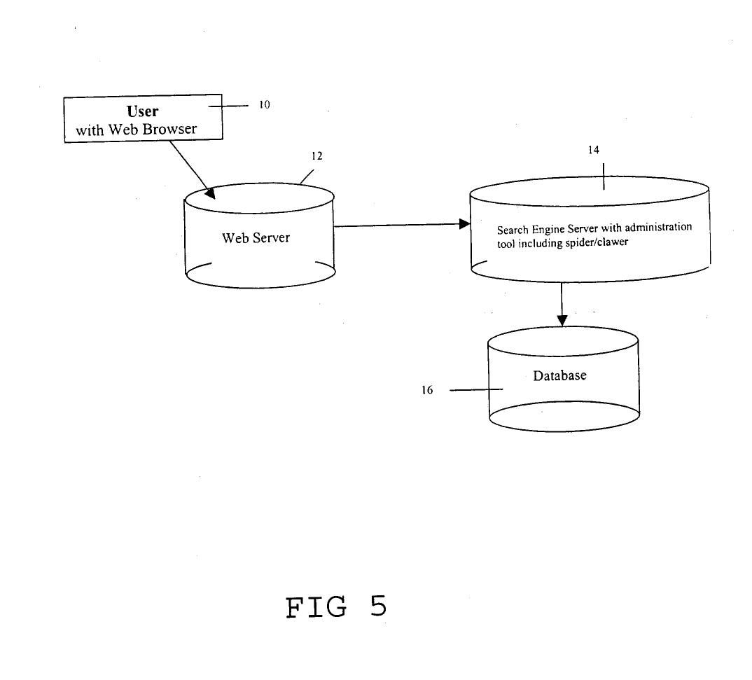

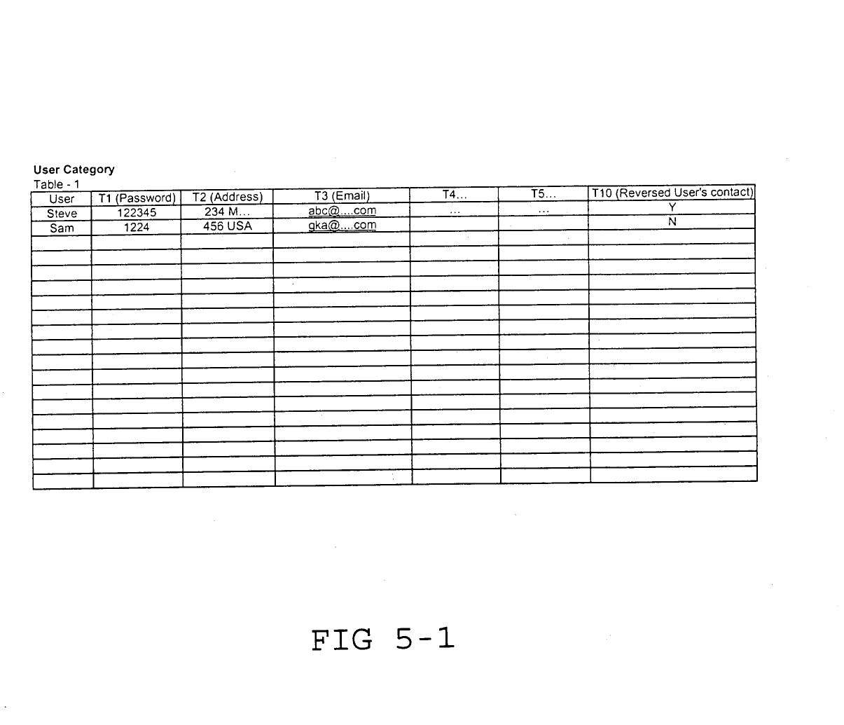

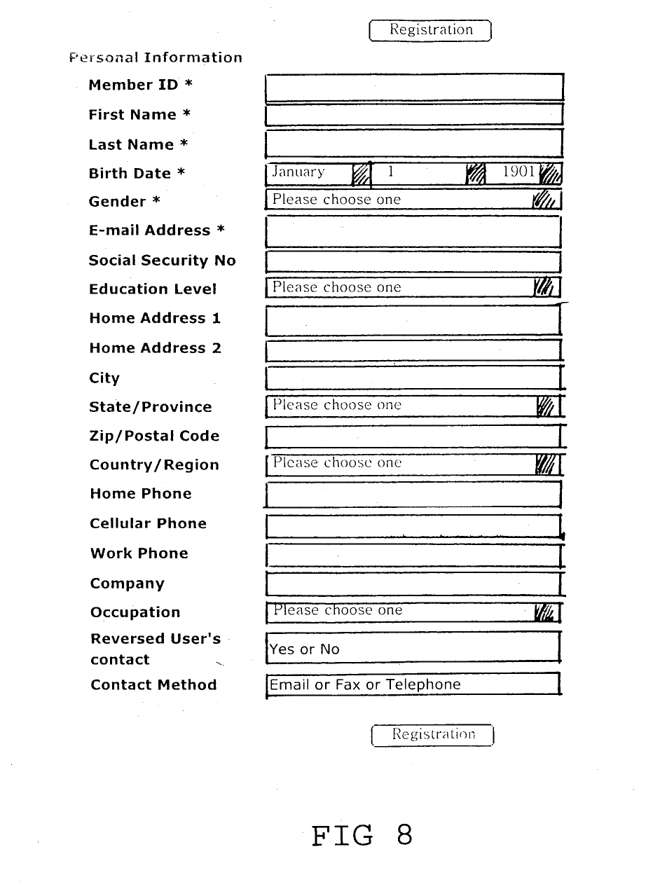

Referring to FIG. 4, user 10 indicates his or her desire to register to receive third party information at block 202. A registration form appears on a screen and user is requested to fill in the information, at block 202-1. A sample of the user registration form is provided in FIG. 8. As well, FIG. 5 depicts a block diagram illustrating the procedure for user 10 registration in database 16 through search engine server 14 and WebServer 12.

Referring back to FIG. 4, the user's personal information, including contact information (the “users profile”) is stored in database 16 (FIG. 1) at block 203. FIG. 5-1 is a table illustrating a series of user database records stored in database 16. The user also designates at block 204 whether he wishes to receive third party information relating to his or her search queries and if so his preferred method of receiving the information. This could be by way of an e-mail, facsimile transmission, telephone call, or other appropriate means. The user's profile is then categorized at block 204-1 in accordance with parameters which may be established by the search engine, for example by permitting grouping of users into those that desire third party contact and those that don't. If the user has made a designation at block 204 to receive third party information, the user's profile is made available for access by third party 18 and registration is concluded.

Referring back to FIG. 2, at block 201, if user 10 is a registered user who wishes to permit third party 18 to provide information directly to user 10, user 10 logs into the Internet WebServer at block 205. The user 10 then searches the Internet, using the Internet search engine in usual manner. That is, the user inputs a search query and the search engine uses that query to locate Internet web sites which may be relevant to that query. The Internet search engine provides user 10 with a list of links and a short description of each Internet WebSite with the search results. The user's search query is stored in database 16 at block 302 and is associated with the user's profile.

User 10 then receives notification that third party 18 will contact user 10 at block 306. The Internet search engine then enables third party 18 to access database. 16 to determine if the user's search query relates to the information which third party 18 wishes to provide to users. It is contemplated that many third parties will be registered with the Internet search engine with information in a variety of topics.

Referring back to block 201, if user 10 does not wish to login as a registered user at block 205, user 10 may undertake Internet searching through the Internet search engine in normal manner, without third party 18 involvement. The user 10 does not log in and provides the search query to the Internet search engine at block 206. The user has not allowed for third party contact by not logging in at block 205, either because user 10 has not registered with the search engine, or if registered has chosen not to log in at block 205. The Internet search engine then provides the search results in the usual manner at block 305.

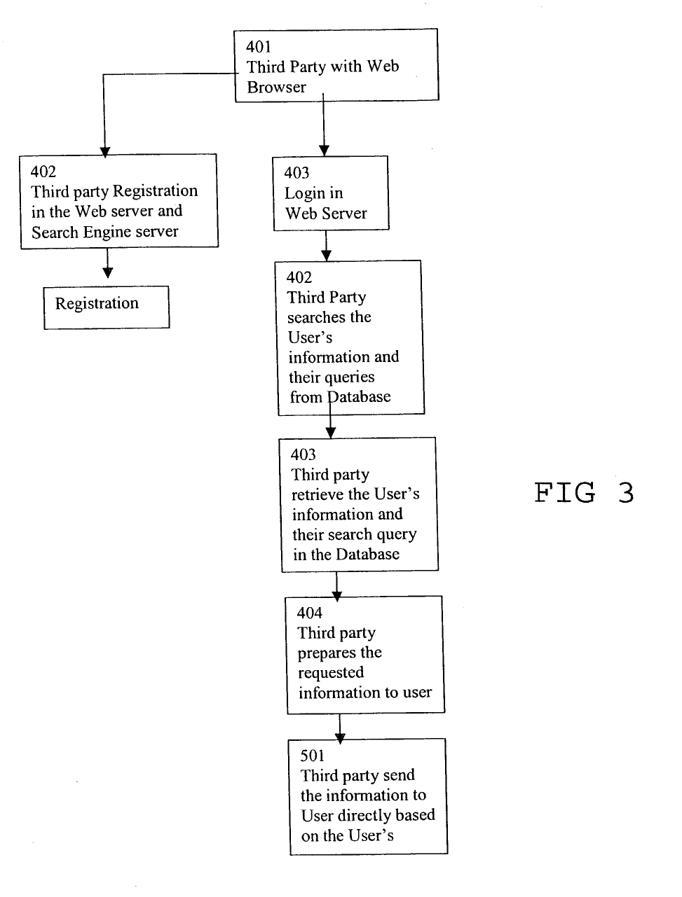

FIG. 3 is a flow chart illustrating the subject invention from the perspective of third party 18. In the event that third party 18 wishes to provide information to user 10 which relates to a search query of user 10, third party 18 accesses WebServer 12 (FIG. 1) at block 401. If third party 18 has not registered with the Internet search engine is required to do so at block 402. Third party 18 provides registration information to the Internet search engine, including the subject matter to which third party 18 information relates. The Internet search engine may require that third party 18 pay an amount to the Internet search engine for privilege of the allowed to access database 16 (FIG. 1) and provide information directly to user 10 in the matter discussed herein.

Once registered, third party 18 logs in to WebServer 12, at block 403. Third party 18 then utilizes a separate server or the server of the Internet search engine in order to search database 16 (FIG. 1) to locate search queries which match the subject matter for which third party 18 is registered, at block 402. If third party 18 does not locate any user's search queries which relates to that subject matter, third party 18 logs off without contacting user 10. If third party 18 locates a user's search query that relates to the subject matter for which third party 18 is registered, third party 18 is permitted to access the user's profile at block 403. Third party 18 then prepares information relating to that subject matter at block 404 and provides user 10 with that information (as depicted at arrow 24 in FIG. 1), at block 501.

For example, third party 18 could be a used car dealer serving a specified geographic location. Third party 18 could be registered with its subject matter relating to automobiles and that geographic location. If user 10 who is registered to receive information from a third party 18 enters a query which contains a word or words relating to an automobile and that geographic location that third party 18 may access the user's profile of user 10 and the search query entered by user 10. The user 10 query could have been “1995 through 2000 Toyota Corolla automobile in Seattle, Wash.”. The dealer's registered location in accordance with its subject matter is the Seattle area. If third party 18 has a 1997 Toyota Corolla it would respond with specific information concerning that automobile, including, if desired by third party 18, the price. The user thereby has the benefit of identifying a vehicle specific to his or her needs and the third party has the benefit of locating user 10 with an active interest in purchasing such an automobile. Both parties benefit from the direct contact between user 10 and third party 18 which has been initiated based on the search query made through the Internet search engine. The search engines reputation is also enhanced by providing more accurate information to user 10 thereby attracting more users to use its search engine. As well, other third parties will see the benefits of registering with such a search engine thereby increasing the revenues of the search engine.

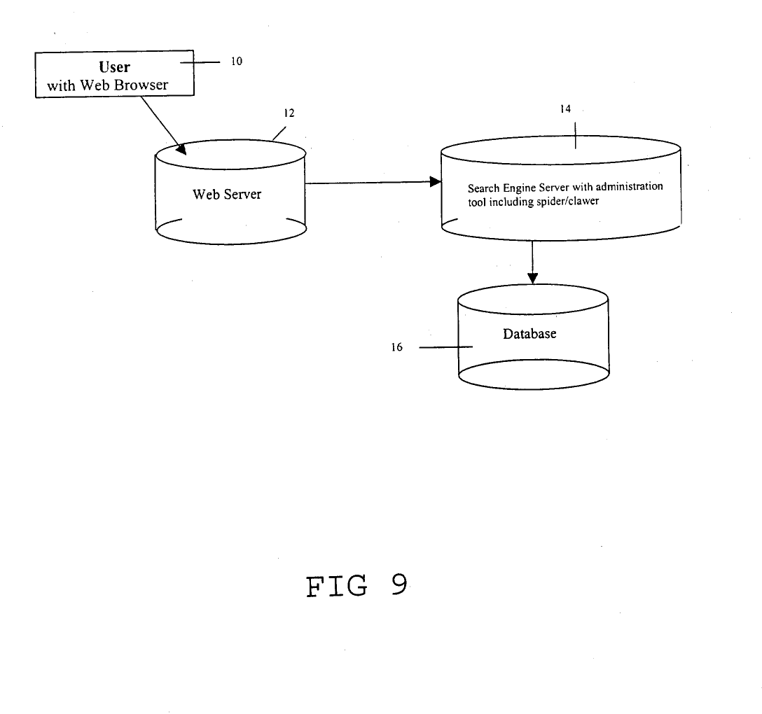

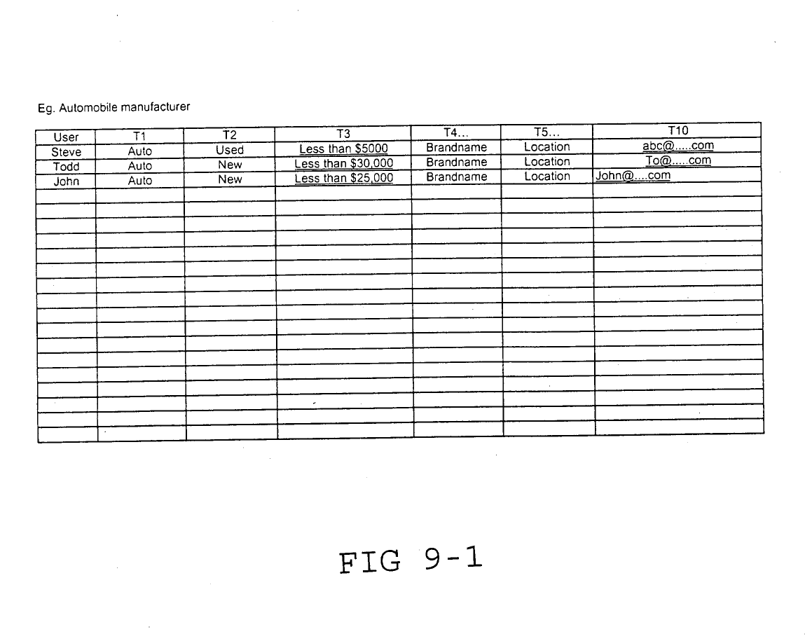

FIG. 9 is a block diagram illustrating the flow of information from user 10 to database 16 by user 10 accessing WebServer 12 of the Internet search engine through the Internet. Search engine server 14 connected to WebServer 12 obtains the user's registration information and stores it in database 16 as the user's profile.

FIG. 9-1 illustrates a table of user database records stored in database 16 including fields for storing user queries. When user 10 enters a query that query is also stored associated with the user's profile in the database 16 either in a field of the record for the user's profile or associated with that record.

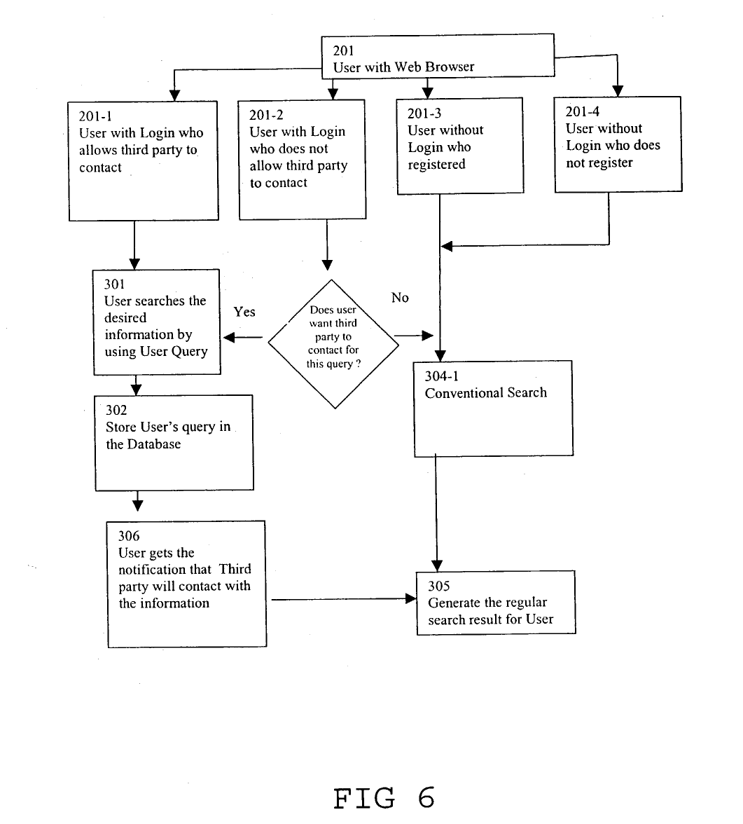

FIG. 6 is a flow chart of the search process in accordance with the present invention. The user 10 with a computer with a Web browser and Internet access (block 201) has four choices when accessing the Internet search engine to undertake a search. At block 201-1 the user can login and allow third party 18 information to be provided to user 10 based on the search query. The user can then undertake an Internet search utilizing the Internet search engine in the usual manner at block 301. The user's query is stored in database 16 (block 302) as part of the record for the user's profile or associated with that record. User 10 then receive notification that third party 18 will contact user with more detailed information, at block 306.

A typical search is then generated at block 305 and the results are provided to user 10.

If user 10 logs in but does not wish to be contacted by third party 18, (block 201-2) he is directed to undertake a conventional search at block 304-1. The search results are generated by the search engine and provided to user 10 at block 305.

If user 10 does not log in then despite the fact that user 10 is registered (block 201-3), user 10 is only permitted to undertake a conventional search at block 304-1 with the results generated by the search engine and provided to user 10 at block 305.

If user 10 is not registered (block 201-4), user 10 may undertake a search in the conventional manner at block 304-1 with the results generated by the search engine and provided to user 10 at block 305.

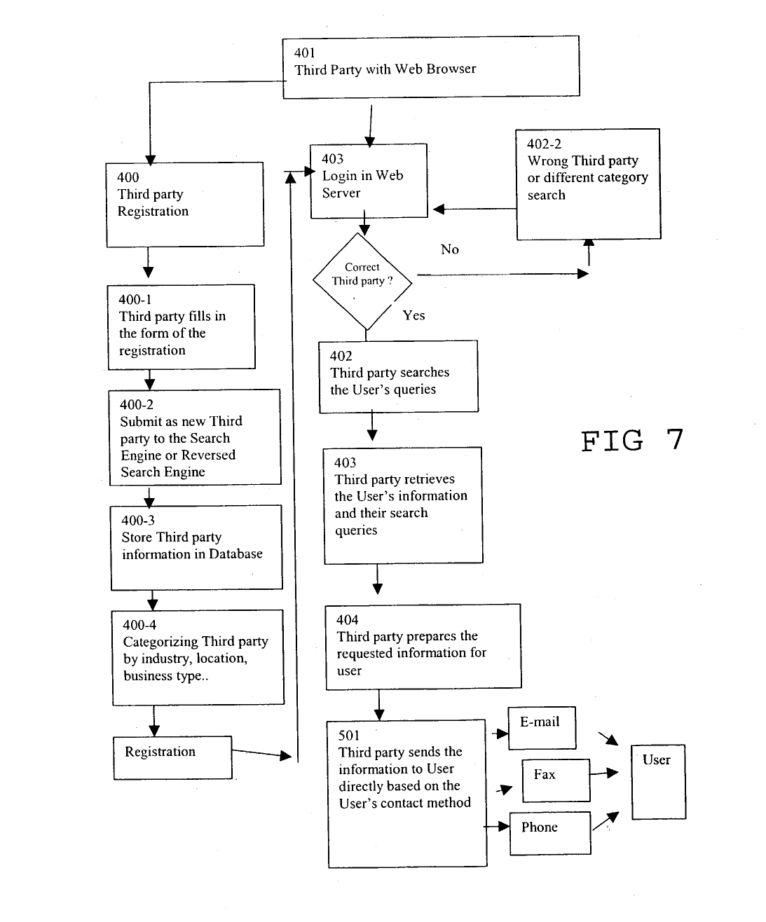

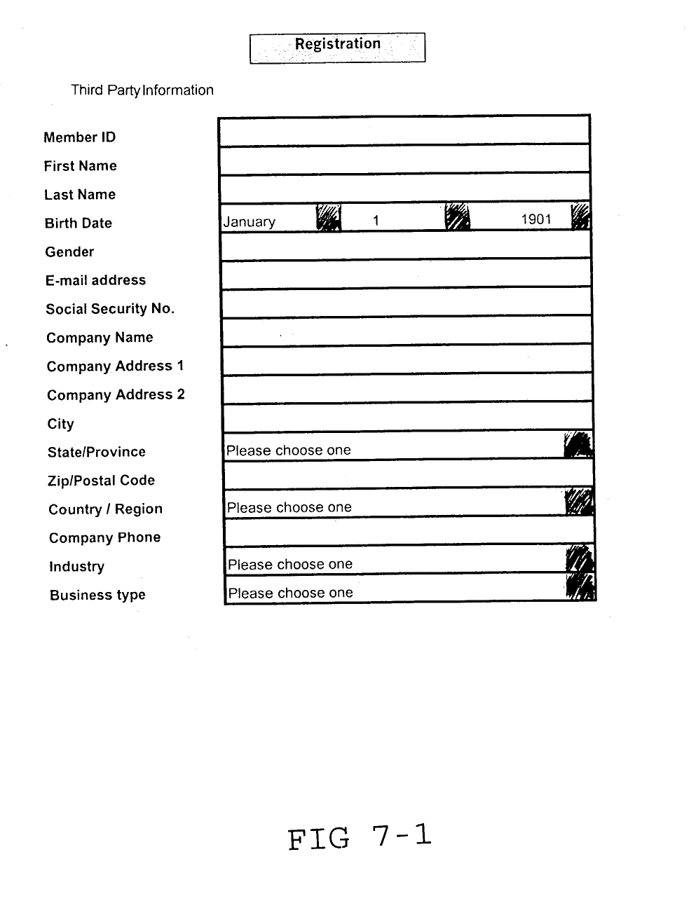

FIG. 7 is a flow chart illustrating the manner in which third party 10 provides information relating to the subject matter for which third party 18 is registered, to a user 10 who submits a search query related to that subject matter.

Third party 18 has a computer with access to the Internet and a Web browser at block 401. If third party 18 has not registered with the Internet search engine third party 18 is directed to a registration process at block 400. Third party 18 completes a registration form, an example of which may be found at FIG. 7-1. The registration form is submitted to the Internet search engine at block 400-2 and is stored in database 16 by the Internet search engine at block 400-3. The registration form includes particulars of the third party information in order to enable the Internet search engine to categorize the third party 18 by industry, location or other relevant parameters to ensure that the information provided to users are relevant to the user's search queries. The third party's information is categorized in accordance with those particulars at block 400-4.

Once registration is complete the third party is permitted to log in WebServer 12 at block 403. Third party 18 is then permitted to search user's queries in data base 16 (FIG. 1) in order to locate queries that relate to the user's subject matter or its category as determined by the Internet search engine, at block 402. If third party 18 locates a user's query that relates to the third party's 18 subject matter or category third party 18 is permitted to access the user's profile associated with that query at block 403. Third party 18 may then examine the query and prepare appropriate information to be sent directly to user 10, at block 404. The information is sent at block 501 by whatever means the user 10 has designated as depicted by arrow 24 in FIG. 1.

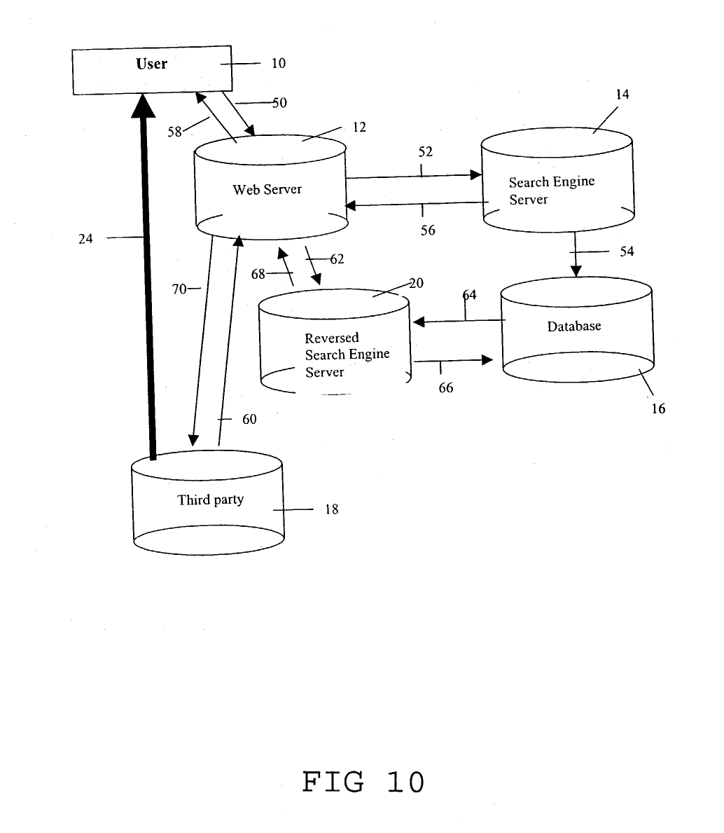

FIG. 10 is a block diagram illustrating the flow of information between the Internet user, the search engine and the third party, when a search query is made. User 10 sends a search query via the Internet to a search engine's WebServer 12, as depicted by arrow 50. That query is sent from WebServer 12 to the search engine's server 14, as depicted by arrow 52. That query is sent by server 14 to database 16 to be stored either in a field of user 10 user's profile or associated with that profile. The transfer of the query from search engine server 14 to database 16 is depicted by arrow 54.

Search engine server 14 undertakes a conventional Internet search and provides the search results to WebServer 12, as depicted by arrow 56. The conventional search results are then sent to user 10 from WebServer 12 via the Internet as depicted by arrow 58. Except for the storage of the query the above process is the same as that undertaken in a conventional Internet search by a search engine.

Third party 18 is registered with the Internet search engine to enable third party 18 to contact user 10 directly, if desired by user 10 and as previously discussed. Third party 18 connects to WebServer 12 via the Internet and enters a search query, based on the registration parameters of third party 18, as depicted by arrow 60. That query is directed by WebServer 12 to reverse search engine server 20, as depicted by arrow 62. As previously discussed, reverse search engine server 20 and search engine server 14 can be the same server, in which case the query would be directed to that combined server. Reverse search engine server 20 then uses the third party 18 query received in order to search database 16, as depicted by arrow 66. If the query matches that of a user profile query previously stored user 10 contact information and the query are provided to reverse search engine server 20, as depicted by arrow 64. Server 20 then provides that information to web server 12, as depicted by arrow 68 which then provides the information to third party 18, as depicted by arrow 70. Third party 18 then prepares information specific to the query of user 10 and provides it to user 10 in the manner requested by user 10, as depicted by arrow 24.

As an optional step, the information to be transmitted by third party 18 can be monitored by the Internet search engine to ensure that the information is relevant to the query of user 10.

The within-described invention may be embodied in other specific forms and with additional options and accessories without departing from the spirit or essential characteristics thereof. The presently disclosed embodiment is therefore to be considered in all respects as illustrative and not restrictive, the scope of the invention being indicated by the appended claims rather than by the foregoing description, and all changes which come within the meaning and range of equivalence of the claims are therefore intended to be embraced therein.

I claim:

1. A method of improving the reliability of search results through an Internet search engine, comprising the steps of:
(a) obtaining contact information from a third party desiring to provide information relating to specific subject matter to an Internet user making a search query relating to that subject matter through the search engine;
(b) storing the third party's contact information and specific subject matter in a third party database record;
(c) obtaining the contact information of an Internet user desiring to make a search query to an Internet search engine web site;
(d) storing that Internet user's contact information in a user database record;
(e) receiving a search query from the Internet user through the Internet search engine;
(f) providing the Internet user with the search results containing web site references based on the search query; and
(g) if the search query of the Internet user relates to the specific subject matter, providing the third party with the Internet user's contact information to enable the third party to contact that Internet user to provide the information relating to the specific subject matter to the Internet user.

2. The method as described in claim 1 wherein:
(a) after step (f), only if the third party's web site reference appears as a part of the search results, proceeding to step (g).

3. The method as described in claim 1 wherein:
(a) at step (c) associating one or more key words with the third party, the key words corresponding to the subject matter;
(b) at step (d) storing the key words in the third party database record;
(c) after step (f), determining key words based on the search query and only if one or more of the keywords associated with the third party match any of the key words based on the search query, proceeding to step (g).

4. The method as described in claim 1 wherein at step (c) obtaining assurances from the third party that the third party will only provide Internet Users with the information relating to the specific subject matter and the third party's contact information.

5. The method as described in claim 1 wherein at step (c) obtaining assurances from the third party that the third party will only contact the Internet User once for each query and only to provide the Internet User with the information relating to the specific subject matter and the third party's contact information.

6. The method as described in claim 1 wherein:
(a) at step (g) advising the third party that a query from the Internet user relates to the specific subject matter.

7. The method as described in claim 1 wherein:
(a) at step (g) providing the third party with the Internet user's contact information is undertaken by providing the Internet user's contact information to the third party whenever the search engine receives a query which relates to the specific subject matter from the Internet user.

8. The method as described in claim 1 wherein:
(a) at step (g) providing the third party with the Internet user's contact information is undertaken by providing access to the third party to the database record of the Internet user making the query that relates to the specific subject matter.

9. The method as described in claim 1 further comprising, after step (g), the step of:
(a) monitoring the information provided by the third party to the Internet user to ensure that only the information relating to the specific subject matter and the third party's contact information are provided by the third party to the user.

10. A system for improving the reliability of search results through an Internet search engine, comprising:
(a) a third party database for storing a record of third party contact information and information relating to specific subject matter provided by the third party;
(b) a Internet user database for storing a record of an Internet user who has agreed to receive the information relating to specific subject matter from the third party;
(c) means for receiving a search query from the Internet user, undertake a search of the Internet based on the search query and providing the search results to the Internet user;
(d) determining means for determining if the search query of the Internet user relates to the specific subject matter stored in the third party database record; and
(e) means for providing the third party with the Internet user's contact information from the Internet user database record to enable the third party to contact that Internet user to provide the information relating to the specific subject matter to the Internet user if the determining means determines that the search query of the Internet user relates to the specific subject matter.

11. A method of linking an Internet user inputting a query using an Internet search engine with a third party desiring to provide information relevant to the query of that Internet user; comprising the steps of:
(a) obtaining the contact information of the Internet user;
(b) storing the Internet user's contact information in an Internet users database record;
(c) obtaining a query from the Internet user through the Internet search engine;
(d) undertaking an Internet search by means of the Internet search engine based on the query and providing the search results to the Internet user; and
(e) providing the Internet users contact information contained in the Internet user's database record to a third party having information relevant to the query to enable the third party to contact the Internet user directly by means of the Internet user's contact information to provide the Internet user with the information relevant to the query.
